(19) United States
(12) Patent Application Publication
(10) Pub. No.: US 2010/0129675 A1
(43) Pub. Date: May 27, 2010

(54) COMPOSITE PANEL, AND METHOD AND SYSTEM FOR MAKING THE SAME

(76) Inventors: Hsien-Te CHENG, Tainan Hsien (TW); Hsien-Sung CHENG, Tainan Hsien (TW)

Correspondence Address: LADAS & PARRY LLP, 224 SOUTH MICHIGAN AVENUE, SUITE 1600, CHICAGO, IL, 60604, US

(21) Appl. No.: 12/422,370

(22) Filed: Apr. 13, 2009

(30) Foreign Application Priority Data
Nov. 21, 2008 (TW) 097145148

(51) Int. Cl. B32B 15/08; B32B 15/04; B29C 47/00

(52) U.S. Cl. 428/461; 428/457; 156/244.24; 156/500

(57) ABSTRACT

A composite panel includes a metal plate and two plastic plates respectively bonded to two opposite surfaces of the metal plate. A system for making the composite panel includes a metal plate advancing unit for advancing the metal plate, two plastic plate supply units for supplying the two hot plastic plates respectively onto the two opposite surfaces of the metal plate, and a pressing unit for pressing the plastic plates against the respective opposite surfaces of the metal plate while the plastic plates are still hot. A method for making the composite panel is also disclosed.

### CROSS-REFERENCE TO RELATED APPLICATION

This application claims priority of Taiwanese application no. 097145148, filed on Nov. 21, 2008.

### BACKGROUND OF THE INVENTION

1. Field of the Invention

This invention relates to a panel, more particularly to a composite panel. This invention also relates to a method and a system for making the composite panel.

2. Description of the Related Art

A conventional plastic panel is available in different colors and is generally used as a partition board for interior decoration or an interior panel for auto body production. Particularly, interior portions of an auto body are mostly made from the plastic panel. However, the plastic panel is generally weak compared to a metal plate, and is more easily damaged due to impact forces. Since the plastic panel used as the partition board or the interior panel is normally a single large piece, once a part of the plastic panel is damaged, the entire plastic panel must be replaced, thereby increasing repair costs.

### SUMMARY OF THE INVENTION

Therefore, the object of the present invention is to provide a strong composite panel that can overcome the aforesaid drawbacks of the prior art, and a method and a system for making the composite panel.

According to one aspect of this invention, there is provided a composite panel that includes a metal plate and two plastic plates respectively bonded to two opposite surfaces of the metal plate.

According to another aspect of this invention, there is provided a method for making a composite panel. The method comprises: extruding two plastic plates respectively onto two opposite surfaces of a metal plate; pressing the plastic plates against the respective opposite surfaces of the metal plate while the plastic plates are still hot so that the plastic plates are bonded to the metal plate; and cooling the plastic plates.

According to yet another aspect of this invention, there is provided a system for making a composite panel. The system includes a metal plate advancing unit for advancing a metal plate, two plastic plate supply units for supplying two hot plastic plates respectively onto two opposite surfaces of the metal plate, and a pressing unit for pressing the plastic plates against the respective opposite surfaces of the metal plate while the plastic plates are still hot so that the plastic plates are bonded to the metal plate.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a sectional view of the preferred embodiment of a composite panel according to this invention;

FIG. 2 is a schematic view of the first preferred embodiment of a system for making the composite panel shown in FIG. 1 according to this invention;

FIG. 3 is a fragmentary magnified view of FIG. 2;

FIG. 4 is a schematic view to illustrate a co-extruder in the second preferred embodiment of the system according to this invention; and

FIG. 5 is a flow chart of the preferred embodiment of a method for making the composite panel shown in FIG. 1 according to this invention.

### DETAILED DESCRIPTION OF THE PREFERRED EMBODIMENTS

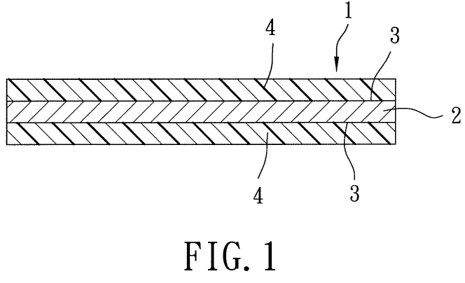

Referring to FIG. 1, the preferred embodiment of a composite panel 1 according to the present invention includes a metal plate 2 and two plastic plates 4 that are respectively bonded to two opposite surfaces of the metal plate 2. The metal plate 2 is made from a material selected from the group consisting of steel and aluminum. Each of the plastic plates 4 is made from a material selected from the group consisting of non-foamed polyethylene, foamed polyethylene, non-foamed polypropylene, and foamed polypropylene. It should be noted that the material used for producing the metal plate 2 and the material used for producing each of the plastic plates 4 are not limited to the aforementioned examples.

Preferably, the composite panel 1 further includes two adhesive films 3. Each of the adhesive films 3 is disposed between the metal plate 2 and a respective one of the plastic plates 4, and is adhereable to the metal plate 2 and the respective plastic plate 4 when softened by heat. Thus, the plastic plates 4 are bonded to the metal plate 2 through the adhesive films 3.

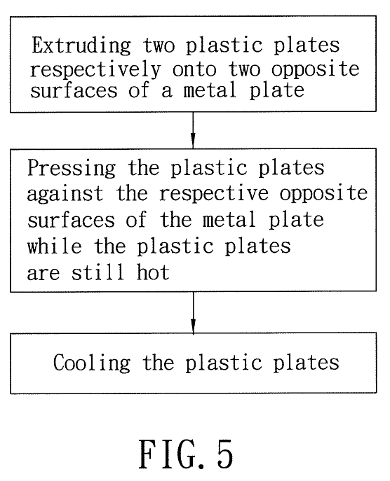

Referring to FIGS. 1 and 5, according to the present invention, a method for making the composite panel 1 includes extruding the two plastic plates 4 respectively onto the two opposite surfaces of the metal plate 2, pressing the plastic plates 4 against the respective opposite surfaces of the metal plate 2 while the plastic plates 4 are still hot so that the plastic plates 4 are bonded to the metal plate 2, and cooling the plastic plates 4.

Preferably, the method further includes applying the two adhesive films 3 respectively to the opposite surfaces of the metal plate 2. The plastic plates 4 are bonded to the metal plate 2 through the adhesive films 3 and pressed against the metal plate 2 via a calendering process.

In an embodiment, the adhesive films 3 are respectively applied to the opposite surfaces of the metal plate 2 before the plastic plates 4 are extruded onto the metal plate 2. The adhesive films 3 are softened by the plastic plates 4 and bond the plastic plates 4 to the metal plate 2 during the pressing of the plastic plates 4.

In another embodiment, each of the plastic plates 4 and a respective one of the adhesive films 3 are co-extruded onto the metal plate 2 such that each of the plastic plates 4 is bonded to a respective one of the opposite surfaces of the metal plate 2 through the respective one of the adhesive films 3.

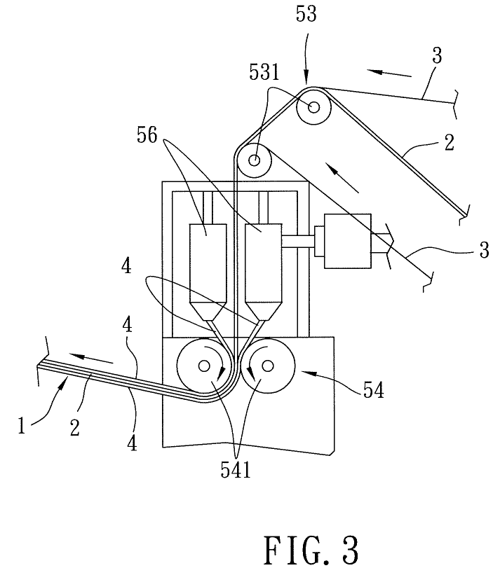

Referring to FIGS. 1, 2, and 3, according to the first preferred embodiment of the present invention, a system 5 for making the composite panel 1 through the aforementioned method includes a metal plate advancing unit 51 for advancing the metal plate 2, two plastic plate supply units 56 for supplying the two hot plastic plates 4 respectively onto the two opposite surfaces of the metal plate 2, and a pressing unit 54 for pressing the plastic plates 4 against the respective opposite surfaces of the metal plate 2 while the plastic plates 4 are still hot so that the plastic plates 4 are bonded to the metal plate 2.

The metal plate advancing unit 51 includes a pair of oppositely rotating rollers 511 which draw and advance the metal plate 2 from a metal plate roll 510.

Preferably, the system 5 further includes two adhesive film supply units 52 for supplying the two adhesive films 3 respectively onto the opposite surfaces of the metal plate 2 so as to bond the hot plastic plates 4 to the metal plate 2. The adhesive film supply units 52 are disposed downstream of the metal plate advancing unit 51 and include unwinding rollers 521 that are disposed respectively on two sides of the metal plate advancing unit 51 to feed the respective adhesive films 3.

In this embodiment, the system 5 further includes an adhesive applying unit 53 that is disposed downstream of the adhesive film supply units 52 and upstream of the plastic plate supply units 56 to apply the adhesive films 3 to the metal plate 2 before the hot plastic plates 4 are supplied to the metal plate 2. The adhesive applying unit 53 includes an upstream guide roller 531 and a downstream guide roller 531.

The plastic plate supply units 56 include extruders to extrude the hot plastic plates 4, respectively. The hot plastic plates 4 contribute heat to soften the adhesive films 3.

The pressing unit 54 is disposed downstream of the plastic plate supply units 56 and includes a pair of press rollers 541 to press the hot plastic plates 4 and the adhesive films 3 against the metal plate 2 such that the plastic plates 4 are bonded to the metal plate 2 through the softened adhesive films 3.

In this embodiment, the upstream guide roller 531 and the downstream guide roller 531 are both disposed upstream of the press rollers 541. The metal plate 2 is moved over the upstream and downstream guide rollers 531 before being drawn to the press rollers 541. One of the adhesive films 3 is moved to the upstream guide roller 531 and over one of the opposite surfaces of the metal plate 2 before being drawn to the press rollers 541 so as to be first applied to one of the opposite surfaces of the metal plate 2. The other one of the adhesive films 3 is moved to the downstream guide roller 531 and over the other one of the opposite surfaces of the metal plate 2 before being drawn to the press rollers 541 so as to be subsequently applied to the other one of the opposite surfaces of the metal plate 2.

Preferably, the system 5 further includes a cooling unit 55 that is disposed downstream of the pressing unit 54 for cooling the plastic plates 4, and that includes a plurality of cooling rollers 551 respectively having a temperature lower than that of the hot plastic plates 4.

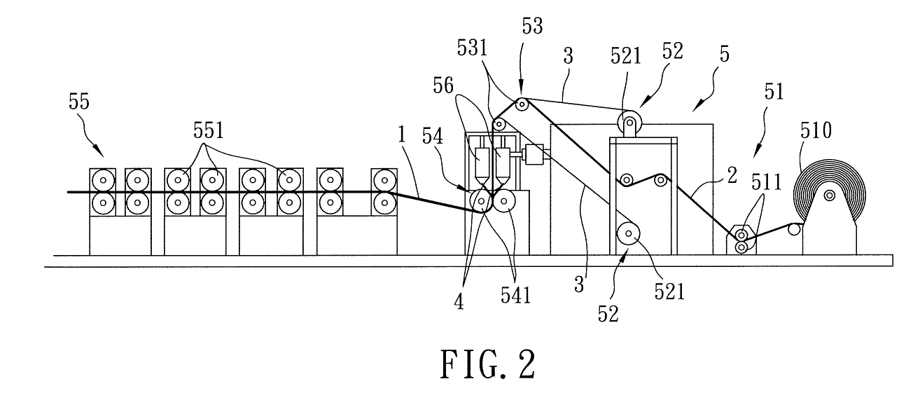

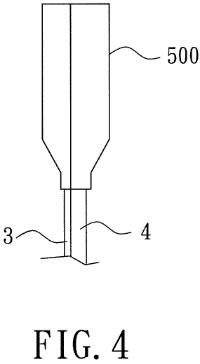

Referring to FIG. 4 in combination with FIG. 2, the second preferred embodiment of the present invention includes two co-extruders 500 (only one is shown), each of which co-extrudes one of the hot plastic plates 4 and one of the adhesive films 3 onto the metal plate 2 in such a manner that one of the plastic plates 4 is bonded to one of the opposite surfaces of the metal plate 2 through one of the adhesive films 3. Therefore, the co-extruders 500 unite the functions of the adhesive film supply units 52 and the plastic plate supply units 56, and each of the co-extruders 500 serves as one of the adhesive film supply units 52 and one of the plastic plate supply units 56 of the first preferred embodiment. The co-extruders 500 are disposed downstream of the metal plate advancing unit 51 and upstream of the pressing unit 54. The adhesive applying unit 53 is dispensed with in the second preferred embodiment.

Due to the use of the metal plate 2 to reinforce the plastic plates 4, the composite panel 1 of the present invention not only has the soft feel characteristics of plastic, but also possesses the robustness of metal. Therefore, the composite panel 1 is not easily damaged by impact force, and the service life thereof can be prolonged compared to the conventional plastic panel.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A composite panel comprising:
a metal plate; and
two plastic plates respectively bonded to two opposite surfaces of the metal plate.

2. The composite panel as claimed in claim 1, further comprising two adhesive films, each of which is disposed between the metal plate and a respective one of the plastic plates.

3. The composite panel as claimed in claim 1, wherein the metal plate is made from a material selected from the group consisting of steel and aluminum.

4. The composite panel as claimed in claim 1, wherein each of the plastic plates is made from a material selected from the group consisting of non-foamed polyethylene, foamed polyethylene, non-foamed polypropylene, and foamed polypropylene.

5. A method for making a composite panel, comprising:
extruding two plastic plates respectively onto two opposite surfaces of a metal plate;
pressing the plastic plates against the respective opposite surfaces of the metal plate while the plastic plates are still hot so that the plastic plates are bonded to the metal plate; and
cooling the plastic plates.

6. The method of claim 5, further comprising applying two adhesive films respectively to the opposite surfaces of the metal plate, the plastic plates being bonded to the metal plate through the adhesive films.

7. The method of claim 5, wherein the plastic plates are pressed against the metal plate through a calendering process.

8. The method of claim 6, wherein the adhesive films are respectively applied to the opposite surfaces of the metal plate before the plastic plates are extruded onto the metal plate, the adhesive films being softened by the hot plastic plates and bonding the plastic plates to the metal plate during the pressing of the plastic plates.

9. The method of claim 6, wherein each of the plastic plates and a respective one of the adhesive films are co-extruded on the metal plate such that each of the plastic plates is bonded to a respective one of the opposite surfaces of the metal plate through the respective one of the adhesive films.

10. A system for making a composite panel, comprising:
a metal plate advancing unit for advancing a metal plate;
two plastic plate supply units for supplying two hot plastic plates respectively onto two opposite surfaces of the metal plate; and
a pressing unit for pressing the plastic plates against the respective opposite surfaces of the metal plate while the plastic plates are still hot so that the plastic plates are bonded to the metal plate.

11. The system as claimed in claim 10, wherein the plastic plate supply units include extruders to extrude the hot plastic plates, respectively.

12. The system as claimed in claim 10, further comprising two adhesive film supply units for supplying two adhesive films respectively onto the opposite surfaces of the metal plate so as to bond the hot plastic plates to the metal plate.

13. The system as claimed in claim 12, wherein the pressing unit includes a pair of press rollers to press the plastic plates and the adhesive films against the metal plate such that the plastic plates are bonded to the metal plate through the adhesive films.

14. The system as claimed in claim 13, wherein the adhesive film supply units include unwinding rollers disposed respectively on two sides of the metal plate advancing unit to feed the respective adhesive films.

15. The system as claimed in claim 14, further comprising an adhesive applying unit disposed upstream of the plastic plate supply units to apply the adhesive films to the metal plate before the hot plastic plates are supplied to the metal plate.

16. The system as claimed in claim 15, wherein the adhesive applying unit includes an upstream guide roller and a downstream guide roller, both of which are disposed upstream of the press rollers, the metal plate being moved over the upstream and downstream guide rollers before being drawn to the press rollers, one of the adhesive films being moved to the upstream guide roller and over the metal plate before being drawn to the press rollers so as to be applied to one of the opposite surfaces of the metal plate, the other one of the adhesive films being moved to the downstream guide roller and over the metal plate before being drawn to the press rollers so as to be applied to the other one of the opposite surfaces of the metal plate.

17. The system as claimed in claim 10, further comprising a cooling unit disposed downstream of the pressing unit for cooling the plastic plates.

18. The system as claimed in claim 17, wherein the cooling unit includes a plurality of cooling rollers that respectively have a temperature lower than that of the hot plastic plates.

19. The system as claimed in claim 13, wherein each of the adhesive film supply units is united with one of the plastic plate supply units as a co-extruder to co-extrude one of the plastic plates and one of the adhesive films such that one of the plastic plates is bonded to one of the opposite surfaces of the metal plate through one of the adhesive films.
